(19) United States
(12) Patent Application Publication
(10) Pub. No.: US 2007/0106764 A1
(43) Pub. Date: May 10, 2007

(54) System and method for device configuration using a portable flash memory storage device with an infrared transmitter

(76) Inventor: Carl Mansfield, Camas, WA (US)

Correspondence Address: THOMAS R. BERTHOLD, 18938 CONGRESS JUNCTION COURT, SARATOGA, CA, 95070, US

(21) Appl. No.: 11/270,237

(22) Filed: Nov. 8, 2005

(51) Int. Cl. G06F 15/177

(52) U.S. Cl. 709/220

(57) ABSTRACT

A system and method for configuring a consumer electronic (CE) device that has an infrared (IR) receiver uses a portable configuration-file transfer device. The CE device may be part of a local area network (LAN) and the configuration file may include network setup parameters, including a network security key, and user personalization data representing user preferences. The configuration file is initially stored in a network hub or configuration controller, such as a PC, or may be downloaded into the hub or PC from a remote internet site. The transfer device has an interface compatible with an interface on the hub or PC to permit transfer of the configuration file, memory for storing the configuration file, and an IR transmitter for transmitting the configuration file to the IR receiver of the CE device. The transfer device may be a compact universal serial bus (USB) “flash drive” modified to include an IR transmitter and a battery for powering the IR transmitter.

### BACKGROUND OF THE INVENTION

1. Field of the Invention

This invention relates generally to transfer of configuration or setup information to a new consumer electronic (CE) device, and more particularly to configuration of a CE device on a local area network (LAN).

2. Description of the Related Art

Consumer electronic (CE) devices, such as stereo receivers, digital video recorders (DVRs), digital televisions (TVs) and audio-video (AV) servers, typically need to be configured with certain setup information before they can operate. The setup information may also include parameters personal to the user of the CE device, such as a favorite-channel list for a TV, so that new parameters may be required to be input each time a new user desires to use the device. CE devices typically include an infrared (IR) interface for input of setup parameters by use of the device's IR remote control, but no conventional personal-computer (PC) type of interface.

CE devices are also becoming common in home and office local area networks (LANs), which permit the transfer of audio and video between devices on the LAN. LANs include wireless local area networks (WLANs), perhaps the most common of which is based on the IEEE 802.11 or Wi-Fi standards, and wired LANs, such as a powerline carrier (PLC) network like that based on the HomePlug™ standard. In most LANs there is a also a need to input configuration or setup information into a new device before it can communicate on the LAN. For example, network configuration information may include a network name and an optional shared network security key that need to be set in the new device. In WLANs there is also a desire for secure communication because the wireless transmissions extend beyond the immediate vicinity of the network devices. In some wired LANs, such as PLC networks, secure communication is also desirable because multiple homes or buildings and multiple-residence buildings such as apartment buildings are usually served from a common transformer so that the physical PLC network extends beyond the boundaries of a single residence. Secure communication is especially important in these types of LANs that have CE devices because copyrighted digital audio and video recordings are transmitted over the LAN.

The network configuration information, including the security key, is typically entered manually into the new device by the user, such as by use of the keypad on the remote control. This can be difficult and annoying for the user. The devices are often from various hardware vendors, each having different configuration steps and remote controls. Additionally, most users do not configure their devices with the network security key because this typically requires the user to manually enter long strings of meaningless characters into multiple devices.

Most homes and offices now have one or more PCs, which may or may not be on a LAN, and which have industry-standard interfaces, such as the universal serial bus (USB) and Personal Computer Memory Card International Association (PCMCIA) interfaces, that permit easy transfer of data files to and from the PC. Many newer PCs also have one or more additional industry-standard interfaces for data transfer, such as Compact Flash (CF) and SecureDigital (SD) interfaces.

What is needed is a system and method for transfer of configuration information from a PC to a CE device to enable easy setup of the CE device, including easy setup for secure communication on a LAN.

### SUMMARY OF THE INVENTION

The invention is a system and method for configuring a CE device that has an IR receiver. The CE device may be part of a LAN and the configuration information may include network setup parameters, including a network security key. The configuration information may also include user personalization data representing user preferences, for example a favorite-channel list if the CE device is a TV. The configuration information is in a data file initially stored in a network hub or configuration controller, such as a PC, or may be downloaded into the hub or PC from a remote internet site. A portable configuration-file transfer device has an interface compatible with an interface on the hub or PC to permit transfer of the configuration file, memory for storing the configuration file, and an IR transmitter for transmitting the configuration file to the IR receiver of the CE device. The transfer device may be a compact USB “flash drive” modified to include an IR transmitter and a battery for powering the IR transmitter. Multiple transfer devices, each with its own personalization data, may be associated with the CE device to enable multiple users to configure the CE device with the user's own preferences.

For a fuller understanding of the nature and advantages of the invention, reference should be made to the following detailed description taken together with the accompanying figures.

### BRIEF DESCRIPTION OF THE DRAWING

FIG. 1 is a high-level block diagram of a network embodiment of the invention that includes a CE device to be configured on the network and a portable file-configuration transfer device.

FIG. 2 is a block diagram of an IEEE 802.11 compliant home WLAN with a digital TV as a network device, and shows a functional block diagram of the portable configuration-file transfer device for transferring the configuration file to the TV.

### DETAILED DESCRIPTION OF THE INVENTION

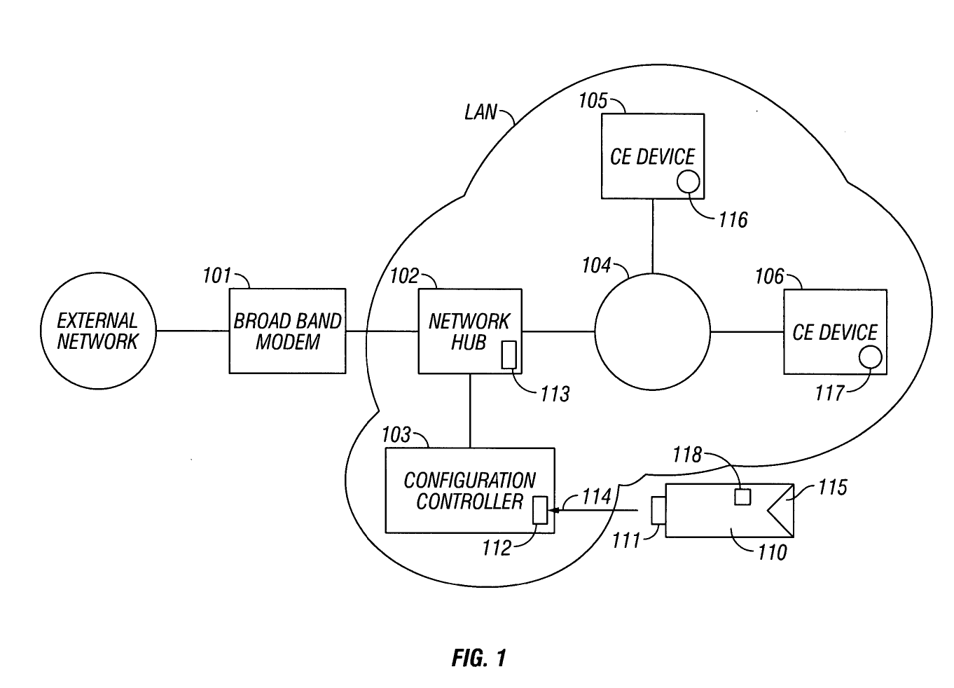

FIG. 1 is a high-level block diagram depicting a network embodiment of the invention that includes a CE device to be configured on a network and a portable file-configuration transfer device. As shown in FIG. 1, an internal or local area network (LAN) is coupled to an external network, such as the Internet, a cable television network, or a satellite communications network, via a broadband modem 101. The LAN operates over an internal wireless or wired network medium 104, and thus may be a wireless LAN (WLAN) like that based on the well-known IEEE 802.11 or Wi-Fi standards, a powerline carrier (PLC) network like that based on the HomePlug™ standard, a coaxial cable network, such as MoCA, or a phoneline network such as HomePNA™. The LAN includes a network controller or hub 102 connected to broadband modem 101. The LAN also includes a configuration controller 103, such as a personal computer (PC), a first consumer electronics (CE) device 105 and a second CE device 106. CE devices 105, 106 include IR receivers 116, 117, respectively. In operation, the LAN receives content from the external communications network and distributes the content over internal medium 104 to CE devices 105 and 106, which are both coupled to the internal medium 104 in a well-known manner. The CE devices 105 and 106 could be, for example, stereo receivers, digital video recorders (DVRs), digital TVs or other content presentation devices.

Configuration controller 103 allows a user to configure network hub 102 in a well-known manner to set up or re-configure the LAN, such as by accessing a webpage-type interface that allows encryption key information and other LAN configuration information to be entered. Once the network hub 102 is configured, a configuration file that contains network encryption key information and other network setup parameters is stored in network hub 102 and optionally in configuration controller 103. The configuration file may also be downloaded automatically or upon request by the user via the external network from a remote internet site and stored in hub 102 or configuration controller 103. The network setup parameters are required to enable a new CE device 105 or 106 to become associated with and communicate on the LAN. Typically these setup parameters are entered manually into the new CE device by the user, such as by use of a keypad on the CE device's remote control.

In the system of this invention a portable configuration-file transfer device 110 includes an interface 111 that mates with interface 112 of configuration controller 103, and an infrared (IR) transmitter 115. For example, interface 111 and interface 112 may be mating USB connectors, or any other type of industry-standard interface commonly used with PCs, such as PCMCIA, Compact Flash (CF), and SecureDigital™ (SD) interfaces. In another example, network hub 102 has an interface 113 that mates with interface 111 of transfer device 110. When interface 111 of transfer device 110 is mated with interface 112 of configuration controller, 103 (or interface 113 of network hub 102), the configuration file can be transferred in a well-known manner into memory contained in transfer device 110. For example, transfer of the configuration file, whether from configuration controller 103 or network hub 102, can occur in response to clicking on a graphical button interface (not shown) that is displayed by configuration controller 103. As another example, transfer of the configuration file can occur automatically when interface 111 is mated (as depicted by line 114) with interface 112 (or interface 113). In yet another example, the transfer occurs in response to actuation of a button (not shown) on either configuration controller 103 or network hub 102.

After the configuration file has been stored in the memory of transfer device 110 it is transferred to a CE device through the IR transmitter 115. CE devices typically include a processor and memory, and an IR receiver or transceiver to receive and/or transmit to a remote control. As depicted in FIG. 1, CE devices 105, 106 include IR receivers 116, 117, respectively. If CE device 106 is a new device not yet on the LAN, then transfer device 110 is brought near the IR receiver 117 and a switch, such as key or button 118, on transfer device 110 is activated to initiate IR transmission. This causes the stored configuration file to be transmitted to CE device 106 and initiates setup of the CE device. The CE device 106 includes software that parses the configuration file to extract the setup parameters. The setup parameters are stored in the memory of CE device 106 and used to configure the CE device for association with the LAN.

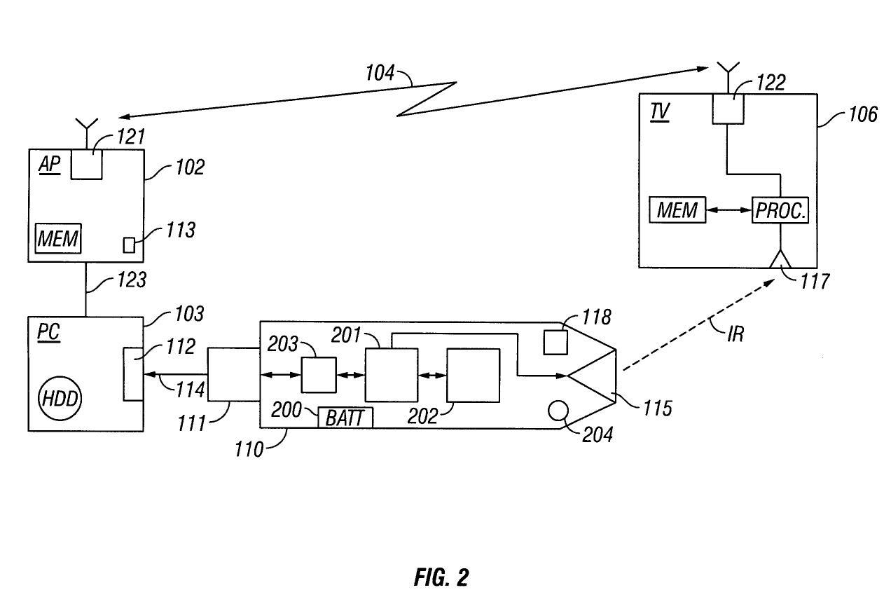

Referring now to FIG. 2, the invention will be described with respect to an IEEE 802.11 compliant WLAN for use as a home network, but the invention is fully applicable to other types of WLANs and to wired LANs such as PLC networks. The WLAN includes the network controller or hub 102, which in an IEEE 802.11 compliant WLAN is called the access point (AP), a PC as the configuration controller 103, and a digital TV, such as a liquid-crystal-display (LCD) TV, as CE device 106. The TV needs to be configured with the network setup parameters so that it can communicate over wireless medium 104 with the AP and other devices on the WLAN. The WLAN may include other CE devices not shown in FIG. 2, such as stereo receivers, digital video recorders (DVRs), other digital TVs, or a satellite TV or cable TV set-top converter. One of the CE devices may also be an audio-video (AV) server, which is typically a PC, DVR or similar device with a hard disk drive (HDD) that stores audio and/or video content.

As shown in FIG. 2, the AP and the TV are each equipped with an IEEE 802.11 wireless transceiver 121, 122, respectively. The PC is shown as being connected to the AP and thus the WLAN by a wired connection 123, but the PC could also communicate with the network by an IEEE 802.11 wireless transceiver. The WLAN configuration file stored in memory in the AP typically includes a network name or service set identifier (SSID), a channel number, and a shared network security key that need to be set in the TV before it can communicate with other network devices. For example, in an IEEE 802.11 compliant WLAN, the shared network security key is based on either the Wired Equivalent Privacy (WEP) or Wi-Fi Protected Access (WPA) encryption standards. The configuration file in the AP may also stored in the PC, typically on a hard disk drive (HDD).

FIG. 2 also shows a functional block diagram of the portable configuration-file transfer device 110 for transferring the configuration file from the PC to the TV. In this example the transfer device will be described as similar to a USB “flash drive” but modified to include a power storage unit 200, IR transmitter 115, and a switch, represented as a “setup” button 118, that initiates IR transmission to set up the CE device. USB flash drives, also known as “pen drives”, “thumb drives”, or “USB keys”, contain flash memory encased in a robust plastic casing, which makes the drive sturdy enough to be carried about in a pocket, as a keyfob or on a lanyard. Only the USB connector protrudes from this plastic protection, and is often covered by a removable plastic cap. The transfer device 110 thus includes a USB connector 111, a controller 201, a USB interface circuit 203 coupling the connector 111 to the controller 201, flash memory 202, an indicator such as light-emitting-diode (LED) 204, a power storage unit 200, IR transmitter 115, and setup button 118. The power storage unit may be a battery or alternatively a capacitor that is charged when the device is connected to the PC and retains the charge long enough to power the IR transmitter 115. The USB interface circuit 203 may alternatively be embedded in controller 201.

To obtain the configuration file from the PC, the USB connector 111 is inserted into the USB interface 112 of the PC, as shown by line 114. The configuration file may also be obtained from the AP if the interface 113 is a USB interface. The PC recognizes the plugged-in USB device as a a removable “drive” and the user then transfers the configuration file from the PC by one of the known techniques for moving files, such as by dragging and dropping an icon or clicking on a graphical button interface displayed by the PC. Alternatively, it is possible to define a new type of USB device other than a “drive”, e.g., a “Home Network configuration key” or “Personalization Key”, which the PC recognizes. This has the advantage that the PC can then trigger specific applications associated with the new type which may then cause more automatic startup of a setup utility or a key-programming utility on the PC.

The configuration file is then stored in flash memory 202. When the controller 201 detects that the configuration file has been received, it activates LED 204. The transfer device 110 is then removed from the PC and moved near the IR receiver 117 of the TV. Setup button 118 on transfer device 110 is then pressed and the stored configuration file is transmitted through IR interface 115. As part of this transmission, the controller 201 formats the data in the configuration file according to a defined IR-based communication protocol. The TV's IR receiver 117 detects and decodes this IR command sequence from the IR-based protocol. An example of a command sequence is as follows:
1. Message code=Network setup data transfer
2. TV recognizes this code and enters a special mode to receive the data
3. IR protocol sequence of data is sent using some predefined protocol and format (e.g., characters as ASCII encoded, XML formatting, etc.)
4. The configuration file format indicates the data elements and their values, for example:
   4.0 Start of data
   4.1 Element ID=SSID, value=Tom's Network
   4.2 Element ID=channel number, value=11
   4.2 Element ID=WEP encryption key, value=4560AC4D . . .
   4.3 End of data

The controller 210 in transfer device 110 may again activate LED 204 to indicate to the user that the configuration file has been transferred. The IR receiver 117 in the TV collects this data and a program run by the processor in the TV parses it to extract the element values. These element values are the network setup parameters that are stored in the TV's memory and used to configure the TV for communication on the WLAN. At this point the TV can now connect to other devices on the WLAN and should be able to verify that it can communicate successfully. This may then be followed by some affirmation that the setup has succeeded, such as a “setup successful” or similar message on the TV's display.

The system shown in FIG. 2 has been described with the transfer device 110 having non-removable or embedded flash memory 201 connected to a USB interface circuit 203 and USB connecter 111. However, the system is also applicable to transfer devices that use other types of memory, such as removable SecureDigital™ (SD) flash memory cards, CompactFlash (CF) flash memory cards, and Compact Flash (CF) hard disk drives, such as the Hitachi Microdrive™. With these types of memory, the transfer device and the PC would each have an appropriate connector and interface for the removable card or drive. The card or drive is inserted into the PC interface, the configuration file is transferred to the card or drive, and the card or drive is then inserted into the transfer device.

The system has been described with the CE device as a LAN device with the configuration file containing setup parameters to enable the CE device to be configured for communication on the LAN. However, the invention is also applicable to a system in which the CE device could be a stand-alone or non-network device or a network-connected device wherein the configuration file contains other data, such as user personalization data, instead of or in addition to network configuration data.

For example, in the case of a digital TV this configuration file may include non-network setup parameters such as screen view mode (Normal, Wide, Zoom), closed-caption option (On, Off) and V-chip secret number, all of which would otherwise be entered using the TV's remote control and a complex command menu displayed on the TV. The configuration file may also include personalization data such as a list of favorite TV channels or other user preferences, in which case an additional data element or elements would be included in the IR data sequence transmitted by the transfer device, for example:
Element ID=favorite-channel list, values=4, 7, 22, 56.
The modified USB flash-drive configuration-file transfer device, because of its compactness and use as a keyfob, increases the practicality of having multiple transfer devices. For example, each family member may use the PC to create his or her own personalization data, such as a favorite-channel list, and then transfer that personal configuration file into his or her own personal keyfob transfer device.

As another example of usage, the CE device may be sold by the manufacturer together with the transfer device and at the time of purchase the retailer may load a configuration file into the transfer device from a PC located in the retail store. The purchaser would then transfer the configuration file into the CE device after the CE device is powered on at the user's home.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A system for configuring a consumer electronic (CE) device comprising:
a portable configuration-file transfer device comprising a processor, memory coupled to the processor, a connector for connection to a configuration controller for receipt of the configuration file into the transfer device's memory, an infrared (IR) transmitter, and a switch for causing the configuration file to be transmitted by the IR transmitter; and
a CE device to be configured comprising an IR receiver, a processor, memory coupled to the processor, and a computer program responsive to the transmitted configuration file.

2. The system of claim 1 further comprising a configuration controller, wherein the configuration controller is a personal computer (PC) having an industry-standard interface, and wherein the transfer device connector has an interface compatible with said PC interface; said PC interface being selected from a universal serial bus (USB), a Personal Computer Memory Card International Association (PCMCIA), a Compact Flash (CF), and a SecureDigital (SD).

3. The system of claim 2 wherein the configuration file is stored in the PC.

4. The system of claim 2 further comprising a local area network (LAN) hub connected to the PC and wherein the configuration file is stored in the hub.

5. The system of claim 1 wherein the configuration file includes user personalization data.

6. The system of claim 1 wherein the configuration file includes network setup parameters for a local area network (LAN).

7. The system of claim 6 wherein the LAN is a powerline carrier (PLC) network.

8. The system of claim 1 wherein the transfer device includes an indicator for indicating either or both (a) receipt of the configuration file from the configuration controller, and (b) IR transmission of the configuration file.

9. A system for configuring a consumer electronic (CE) device on a local area network (LAN) comprising:
a personal computer (PC) containing a configuration file including LAN setup parameters and having an industry-standard interface selected from a universal serial bus (USB), a Personal Computer Memory Card International Association (PCMCIA), a Compact Flash (CF), and a SecureDigital (SD);
a portable configuration-file transfer device comprising a connector for connection to said PC interface, a processor, memory coupled to the processor for storage of the configuration file transferred from the PC across said interface, an infrared (IR) transmitter, and a setup button for causing the configuration file to be transmitted by the IR transmitter; and
a CE device to be configured on the LAN comprising an IR receiver for receiving the IR-transmitted configuration file, a processor, memory coupled to the processor, and a computer program responsive to the configuration file.

10. The system of claim 9 wherein the configuration file includes user personalization data.

11. The system of claim 9 wherein the LAN is a powerline carrier (PLC) network.

12. The system of claim 9 wherein the LAN is a wireless local area network (WLAN) and the setup parameters include a network security key.

13. The system of claim 9 further comprising a network hub connected to the PC and wherein the LAN setup parameters are transferred from the hub to the PC over the LAN.

14. A portable configuration-file transfer device comprising:
a universal serial bus (USB) connector;
a controller;
a USB interface circuit coupling the USB connector to the controller;
flash memory coupled to the controller;
a data file including consumer electronic (CE) device setup parameters stored in the flash memory;
an infrared (IR) transmitter;
a setup button for causing IR transmission of the stored data file; and
a power storage unit for powering the IR transmitter.

15. The transfer device of claim 14 wherein the data file includes user personalization data.

16. The transfer device of claim 14 further comprising an indicator coupled to the controller for indicating IR transmission of the data file.

17. The transfer device of claim 14 wherein the power storage unit comprises a capacitor.

18. A method for transferring consumer electronic (CE) device configuration data from a personal computer (PC) having a universal serial bus (USB) interface to a CE device having an infrared (IR) receiver, the method comprising:
providing a portable data-file transfer device that includes a USB connector, a controller, a USB interface circuit coupling the USB connector to the controller, flash memory coupled to the controller, an infrared (IR) transmitter, a switch for causing IR transmission, and a power storage unit for powering the IR transmitter;
inserting the transfer device's USB connector into the USB interface on the PC;
transferring the configuration data from the PC to the flash memory of the transfer device;
removing the transfer device from the PC;
locating the transfer device near the IR receiver of the CE device; and
activating the switch on the transfer device to cause IR transmission of the configuration data from the flash memory to the CE device.

19. The method of claim 18 further comprising inputting the configuration data into the PC before transferring the configuration data from the PC to the flash memory.

20. The method of claim 19 wherein the PC has internet connectivity and wherein inputting the configuration data into the PC comprises downloading the configuration data from a remote internet site to the PC.

21. The method of claim 19 wherein the PC has local area network (LAN) connection to a network hub, and wherein inputting the configuration data into the PC comprises transferring the configuration data from the hub to the PC.

22. The method of claim 19 wherein inputting the configuration data into the PC comprises inputting user personalization data into the PC.

23. The method of claim 19 wherein the power storage unit in the transfer device comprises a capacitor and wherein inserting the transfer device's USB connector into the USB interface on the PC comprises charging the capacitor.
